(19) United States
(12) Patent Application Publication
(10) Pub. No.: US 2011/0146816 A1
(43) Pub. Date: Jun. 23, 2011

(54) DEVICE FOR DISINFECTING A MOTOR VEHICLE AIR-CONDITIONING SYSTEM

(75) Inventors: Maxime Makarov, Viroflay (FR); Kahina Bouamra, Massy (FR); Menouar Ameziani, Guyancourt (FR)

(73) Assignee: Renault S.A.S., Boulogne-Billancourt (FR)

(21) Appl. No.: 12/991,297

(22) PCT Filed: Apr. 29, 2009
(86) PCT No.: PCT/FR09/50787

§ 371 Date: Mar. 7, 2011

(30) Foreign Application Priority Data
May 7, 2008 (FR) 0853016

(51) Int. Cl. F15D 1/02

(52) U.S. Cl. 137/544

(57) ABSTRACT

The invention relates to a device (11) for disinfecting a motor vehicle air-conditioning system (1), said air-conditioning system (1) including: a) circulation means (5) intended to circulate air through an air delivery duct (6) and placed one after the other in said air delivery duct (6) in the direction of air circulation, b) an air filter (8), and c) an evaporator (7). The invention is characterized in that the device (11) includes: a bypass (12) bypassing the evaporator (7) and enabling air circulation between an area located downstream from the evaporator (7) and an area located between the filter (8) and the evaporator (7), a pump (17) capable of circulating the air from the area located downstream from the evaporator (7) to the area located between the filter (8) and the evaporator (7) via the bypass (12), and a plasma generator (18) capable of generating ozone in the bypass (12).

The subject of the present invention is a device for disinfecting a motor vehicle air-conditioning system. A further subject thereof is a motor vehicle fitted with such a device.

Motor vehicles are enclosed locations of small volume subjected to changing and often severe environments. It is therefore essential to renew the air therein regularly and to regulate the temperature thereof.

For this purpose air-conditioning systems, or air conditioners, are used. These systems are designed so that the heated or cooled air is blown into the vehicle.

Motor vehicle air-conditioning systems, in particular HVAC (Heating, Ventilation and Air-Conditioning) systems usually contain an air circuit between at least one inlet vent and at least one exhaust vent, on which various air-treatment means are interposed. The air inlet vent is an entrance for outside air and/or an entrance for recycled air. The air treatment means are notably ventilation means for setting an airstream in motion through the circuit, heating and/or cooling means, such as for example an evaporator, and air purification means, notably by filtration, by ionization, by photocatalysis or similar means. The evaporator designed to cool the air is usually placed downstream of an air filter so as not to be damaged by pollutant particles that are present in the air.

Amongst the air treatment means, those using a plasma generator, and notably an ozone generator, designed to prevent the development of microorganisms that are responsible for bad air-conditioning odors which are a source of discomfort for the passengers are known. Such microorganisms develop notably close to the evaporator. The ozone generated is then carried away by the air stream and blown by the ventilation means and thus passes through the evaporator.

Documents DE 10 2004 030 275 and EP 1 867 346 disclose an electric plasma reactor of the corona type furnished with thin metal filaments raised to a high voltage and stretched across the ventilation air stream between the front face of the evaporator and the air filter.

This system is however quite voluminous and therefore requires considerable space upstream of the evaporator.

Also known is a dielectric barrier discharge (DBD) electric plasma reactor comprising metal electrodes situated on both sides of a thin dielectric material and raised to a high AC voltage such as for example the reactor marketed under the name AQC® by Paragon. Such a reactor is attached to the wall of the air-conditioning system between the evaporator and the air filter.

This type of reactor is more compact than the corona reactors, but it is not possible to place it in the middle of the airstream which means that the distribution of the ozone over the surface of the evaporator is not uniform and is difficult to control. Moreover, for an efficient operation, the generating portion of the device has to be swept by the airstream in order to discharge the ozone which is around the generating portion. Specifically, if there is too much ozone, the ozone recombines to form oxygen and the disinfector loses its efficiency. The air speed close to the wall on which the generator is mounted in the DBD reactor is virtually zero.

Moreover, more generally, the geometry of most of the air-conditioning systems, and in particular of the HVAC systems, is such that the space between the air filter and the evaporator is very small, of the order of a few millimeters, which means that there is not very much room available upstream of the evaporator to place the plasma generator.

The object of the present invention is to remedy these drawbacks.

In particular, the invention proposes a plasma device for disinfecting a motor vehicle air-conditioning system, the device being capable of generating ozone which passes through the evaporator, the plasma-generating portion being swept by an airstream, the device also being suitable for a small space between the main filter and the evaporator.

The subject of the invention is therefore a device for disinfecting an air-conditioning system for a motor vehicle, the air-conditioning system comprising: a) means for circulating air in an air-delivery duct, and, placed in succession in said air-delivery duct, in the direction of circulation of the air, b) an air filter and c) an evaporator.

The disinfection device according to the invention comprises:

a bypass bypassing the evaporator and allowing a circulation of air between a zone situated downstream of the evaporator and a zone situated between the filter and the evaporator,

a pump capable of circulating the air from the zone situated downstream of the evaporator to the zone situated between the filter and the evaporator, via the bypass, and

a plasma generator capable of generating ozone in the bypass.

Therefore, the bypass allows the plasma generator to be incorporated into air-conditioning systems with little available space. The air that is already filtered is drawn downstream of the evaporator and is blown upstream of the evaporator with the aid of the pump. It therefore blows the ozone generated by the plasma generator in the bypass over the front face of the evaporator.

The bypass may comprise one or more tubes mounted on the air-delivery duct or a double wall of the air-delivery duct. The use of several tubes makes it possible to homogenize the exposure of the evaporator to the plasma.

The tubes are preferably made of plastic and notably of polymer, compatible with ozone, in order to prevent corrosion of the tube.

The bypass is advantageously a double wall extending over the whole depth of the air-delivery duct. This gives uniform exposure of the evaporator to the ozone.

A further subject of the invention is an air-conditioning system for a motor vehicle comprising a device described above and a motor vehicle comprising a device described above.

Other advantages and features of the invention will appear on reading the following description given only as a nonlimiting example, and made with reference to the appended drawings in which:

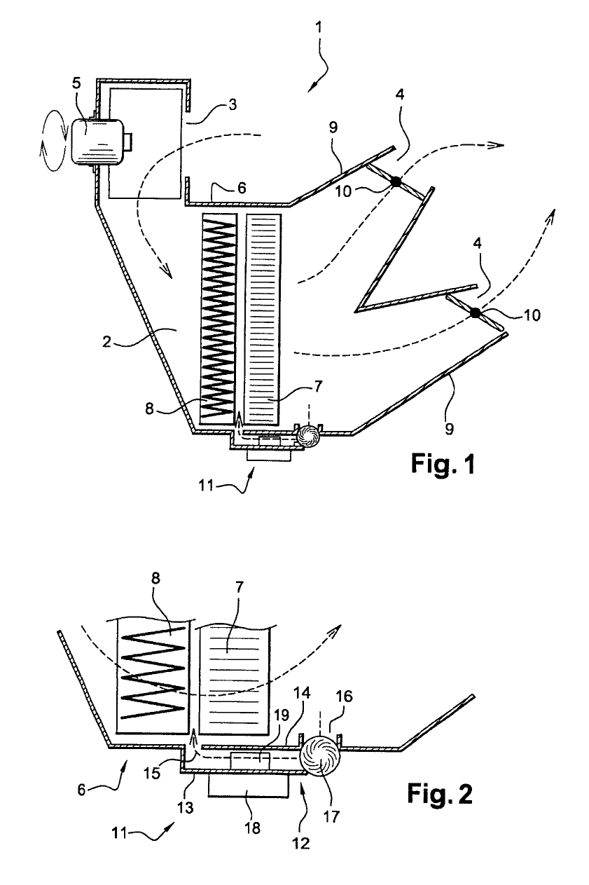

FIG. 1 illustrates schematically a motor vehicle air-conditioning system furnished with a disinfection device according to the invention,

FIG. 2 is a detailed view of the air-conditioning system, and

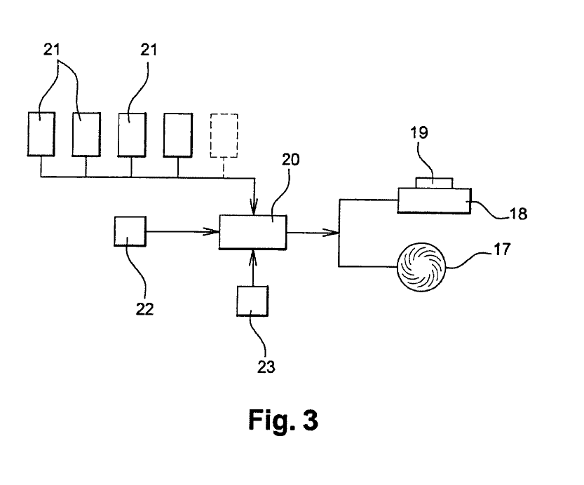

FIG. 3 illustrates in the form of a block diagram a system for controlling the disinfection device according to the invention.

The motor vehicle air-conditioning system 1, as illustrated in FIG. 1, comprises an air circuit 2 from at least one inlet vent 3 through which the air enters. The inlet vent 3 is the entrance for outside air or the entrance for recycled air. The system 1 also comprises a plurality of outlet vents 4 deigned to ventilate specific zones of the passenger compartment, or even a seat or another member of the vehicle.

The air circuit 2 notably comprises an air blower 5, capable of setting in motion the air originating from the inlet vent 3, a duct 6 for delivering the air thus circulated to a thermal treatment zone which comprises an evaporator 7 and a filter 8, a particle or similar filter, placed upstream and close to the evaporator 7. The filter 8 and the evaporator 7 are placed inside the air-delivery duct 6. The arrows indicate the direction of travel of the air.

The air circuit 2 also comprises a plurality of ducts 9 for exhausting the air in the direction of the zones and/or members to be ventilated, the exhaust ducts 9 lead to flaps 10 for regulating the air stream that are capable of regulating the flow rate of air in the passenger compartment.

The filter 8 is designed to trap the various elements traveling in the air circuit 2 and notably particles, dust, insects or pollen. It is possible, for example, to use as a filter 8 an active carbon filter or a pollen filter.

The evaporator 7 is a heat exchanger. Its role is to absorb the thermal stream originating from the air to be cooled. The evaporator 7 therefore comprises a liquid coolant fluid which is vaporized by the heat extracted from the air to be cooled.

The air circuit 2 may also comprise other air-treatment members, not shown, such as for example an ionizer, a device for treatment by photocatalysis, a device for treatment by electrostatic precipitation and/or any other air-treatment device.

The air-conditioning system 1 finally comprises a disinfection device 11 according to the invention.

The disinfection device 11 is shown in detail in FIG. 2 in which the elements that are identical to those in FIG. 1 bear the same reference numbers. As illustrated in FIG. 2, the device 11 comprises a bypass 12 which forms part of the air-delivery duct 6. The bypass 12 connects a zone situated downstream of the evaporator 7 to a zone situated between the filter 8 and the evaporator 7. The bypass 12 comprises for example a double wall 13, 14 of the air-delivery duct 6. The double wall 13, 14 comprises an outer wall 13 forming the wall of the air-conditioning system 1 and an inner wall 14 furnished with two orifices 15, 16. A first orifice 15 leads into the space situated between the air filter 8 and the evaporator 7, while a second orifice 16 leads into the space situated downstream of the evaporator 7.

The bypass 12 can for example extend over the whole depth of the air-delivery duct 6.

In a variant not illustrated, the bypass 12 may comprise a plurality of tubes connecting the zone situated downstream of the evaporator 6 to the zone situated between the filter 8 and the evaporator 7. Each tube therefore connects two orifices made in the air-delivery duct 6, a first orifice leading to the inside of the air-delivery duct 6, in the space situated between the air filter 8 and the evaporator 7, while a second orifice leads to the inside of the air-delivery duct 6, into the space situated downstream of the evaporator 7.

The device 11 also comprises a pump 17 and an ozone generator 18. The pump 17 is designed to circulate clean air originating from the evaporator 7 from the zone situated downstream of the evaporator 7 to the zone situated between the filter 8 and the evaporator 7, via the bypass 12.

The air originating from the evaporator 7 is therefore reinjected upstream of the evaporator 7, via the bypass 12, without passing through the evaporator 7.

The pump 17 may be placed anywhere in the bypass 12, preferably at the orifice 16 leading into the space situated downstream of the evaporator 7 for better blowing of the air. Care must be taken preferably to design the pump 17 so that the generated air flow rate is sufficient to blow the ozone far enough into the main duct 6 of the air-conditioning system 1. For this purpose, it will be typically possible to use an air microblower with, for example, a flow rate of the order of a few cm³/s or even a few cm³/min.

The ozone generator 18, also called an ozoner, ozonizer or ozonator, is attached to the outer wall 13 of the air-delivery duct 6. The ozone generator 18 is furnished with a generating portion 19 which is placed inside the bypass 12, the airstream generated by the pump 17 draws the ozone produced by the generating portion 19 of the ozone generator 18 which is then blown out of the bypass 12 onto the upstream face of the evaporator 7 by this same auxiliary air stream.

In one variant, the pump 17 may form part of the ozone generator 18. It may, for example, be incorporated directly into the generating portion 19 of the ozone generator 18.

If the bypass 12 comprises a plurality of tubes, the use of several tubes makes it possible to better distribute the air stream generated by the pump 17 over the whole of the evaporator 7.

FIG. 3, in which elements that are identical to those of FIG. 2 bear the same reference numbers, illustrates a system for controlling the disinfection device according to the invention. A control device 20, or a computer, is connected to sensors 21 indicating, for example, the temperature, the humidity, the presence of passages, or else the position of the flaps. The control device 20 is also connected to an ON control indicator 22, for example a main control device and to an indicator 23 of the state of the air-conditioning system, indicating, for example, whether it is operating, or the air flow rate. The control device 20 is finally connected to the ozoner 18 and to the pump 17. The control device 20 is therefore, for example, capable of controlling the voltage applied and/or the duration of activation of the ozoner 18, and the rotation speed of the fan of the pump 17.

The ozoner 18 can be started manually by the driver of the vehicle, or automatically by the control device 20 at the same time as the pump 17.

The disinfection device according to the invention therefore makes it possible to reduce the bad air-conditioning odors inside a motor vehicle by effectively destroying the microorganisms deposited on the evaporator of the air-conditioning system. It makes it possible to spread the ozone stream uniformly toward the evaporator. By virtue of the device, the generating portion of the ozoner is continuously swept by a stream of pure air which prevents self-destruction of the ozone and the generating portion of the ozoner remains clean. These advantages are obtained even with very short distances between the air filter and the evaporator.

Moreover, since the evaporator is wetter and therefore more polluted in the lower portion thereof, the device according to the invention, placed closed to the lower portion of the evaporator, makes it possible to effectively disinfect this portion of the evaporator.

Although the disinfection device according to the invention can be used in any type of air-conditioning system, it is particularly suitable for air-conditioning systems of the HVAC type.

1. A device for disinfecting an air-conditioning system for a motor vehicle, the air-conditioning system comprising:
a) means for circulating air in an air-delivery duct, and, placed in succession in said air-delivery duct, in the direction of circulation of the air,
b) an air filter and
c) an evaporator, wherein the device comprises:
a bypass bypassing the evaporator and allowing a circulation of air between a zone situated downstream of the evaporator and a zone situated between the filter and the evaporator,
a pump capable of circulating the air from the zone situated downstream of the evaporator to the zone situated between the filter and the evaporator, via the bypass, and
a plasma generator capable of generating ozone in the bypass.

2. The device as claimed in claim 1, wherein the bypass comprises one or more tubes mounted on the air-delivery duct.

3. The device as claimed in claim 1, wherein the bypass comprises a double wall of the air-delivery duct.

4. The device as claimed in claim 3, wherein the double wall extends over the whole depth of the air-delivery duct.

5. An air-conditioning system for a motor vehicle, wherein said system comprises a device as claimed in claim 1.

6. A motor vehicle, comprising a device as claimed in claim 1.
